(19) United States
(12) Patent Application Publication
(10) Pub. No.: US 2005/0194070 A1
(43) Pub. Date: Sep. 8, 2005

(54) Lower fluence boundary oblique laser shock peening

(76) Inventors: Seetha Ramaiah Mannava, Cincinnati, OH (US); William Woodrow Shepherd, West Chester, OH (US)

Correspondence Address: Steven J. Rosen;Patent Attorney, 4729 Cornell Rd., Cinicinnati, OH, 45241, US

(21) Appl. No.: 10/791,576

(22) Filed: Mar. 2, 2004

(51) Int. Cl. B23K 26/00

(52) U.S. Cl. 148/525; 219/121.85

(57) ABSTRACT

A laser shock peening method including laser shock peening a first area with at least one high fluence normal laser beam and laser shock peening a border area between the first area and a non-laser shock peened area of the article with at least one first low fluence oblique laser beam. The border area may be laser shock peened with two or more low fluence oblique laser beams. The second low fluence oblique laser beam and others have a lower fluence than the first low fluence oblique laser beam. The border area may be laser shock peened with progressively lower fluence oblique laser beams starting with the one first fluence oblique laser beam wherein the progressively lower fluence oblique laser beams are in order of greatest fluence to least fluence in a direction outwardly from the first area through the border area to the non-laser shock peened area.

### BACKGROUND OF THE INVENTION

1. Field of the Invention

This invention relates to laser shock peening and, more particularly, to methods and articles of manufacture employing laser shock peening a boundary area bordering a laser shock peened surface with a lower fluence oblique laser beam.

2. Description of Related Art

Laser shock peening or laser shock processing, as it is also referred to, is a process for producing a region of deep compressive residual stresses imparted by laser shock peening a surface area of an article. Laser shock peening typically uses one or more radiation pulses from high energy, about 50 joules or more, pulsed laser beams to produce an intense shockwave at the surface of an article similar to methods disclosed in U.S. Pat. No. 3,850,698 entitled “Altering Material Properties”; U.S. Pat. No. 4,401,477 entitled “Laser Shock Processing”; and U.S. Pat. No. 5,131,957 entitled “Material Properties”. The use of low energy laser beams is disclosed in U.S. Pat. No. 5,932,120, entitled “Laser Shock Peening Using Low Energy Laser”, which issued Aug. 3, 1999 and is assigned to the present assignee of this patent. Laser shock peening, as understood in the art and as used herein, means utilizing a pulsed laser beam from a laser beam source to produce a strong localized compressive force on a portion of a surface by producing an explosive force at the impingement point of the laser beam by an instantaneous ablation or vaporization of a thin layer of that surface or of a coating (such as tape or paint) on that surface which forms a plasma.

Laser shock peening is being developed for many applications in the gas turbine engine field, some of which are disclosed in the following U.S. Pat. No. 5,756,965 entitled “On The Fly Laser Shock Peening”; U.S. Pat. No. 5,591,009 entitled “Laser Shock Peened Gas Turbine Engine Fan Blade Edges”; U.S. Pat. No. 5,531,570 entitled “Distortion Control For Laser Shock Peened Gas Turbine Engine Compressor Blade Edges”; U.S. Pat. No. 5,492,447 entitled “Laser Shock Peened Rotor Components For Turbomachinery”; U.S. Pat. No. 5,674,329 entitled “Adhesive Tape Covered Laser Shock Peening”; and U.S. Pat. No. 5,674,328 entitled “Dry Tape Covered Laser Shock Peening”, all of which are assigned to the present Assignee.

Laser shock peening has been utilized to create a compressively stressed protective layer at the outer surface of an article which is known to considerably increase the resistance of the article to fatigue failure as disclosed in U.S. Pat. No. 4,937,421 entitled “Laser Peening System and Method”. These methods typically employ a curtain of water flowed over the article or some other method to provide a plasma confining medium. This medium enables the plasma to rapidly achieve shockwave pressures that produce the plastic deformation and associated residual stress patterns that constitute the LSP effect. The curtain of water provides a confining medium, to confine and redirect the process generated shockwaves into the bulk of the material of a component being LSP'd, to create the beneficial compressive residual stresses.

The pressure pulse from the rapidly expanding plasma imparts a traveling shockwave into the component. This compressive shockwave initiated by the laser pulse results in deep plastic compressive strains in the component. These plastic strains produce residual stresses consistent with the dynamic modulus of the material. The many useful benefits of laser shock peened residual compressive stresses in engineered components have been well documented and patented, including the improvement on fatigue capability. These compressive residual stresses are balanced by the residual tensile stresses in the component. The added residual tensile stresses may locally lower fatigue capability of components and, thus, should be reduced and/or minimized. The laser shock peening is performed at selective locations on the component to solve a specific problem. The balancing tensile stresses usually occur at the edge of the laser shock peened area. Small narrow bands or lines of tensile stresses can build up immediately next to the laser shock peened patch or area along the edges of the patch. Extensive finite element analyses are done to determine where these tensile stresses will reside and the LSP patches are designed and dimensioned such that the tensile band(s) end up in an inert portion of the article or component (e.g. not at a high stress line in one of the flex, twist or other vibratory modes). It is desirable to reduce the level of these tensile stresses in the transition area between the laser shock peened and non-laser shock peened areas.

### SUMMARY OF THE INVENTION

A method for laser shock peening an article including laser shock peening a first area with at least one high fluence normal laser beam at a first surface of the first area and laser shock peening a border area between the first area and a non-laser shock peened area of the article with at least one first low fluence oblique laser beam at the border area. In one particular embodiment of the method, the first low fluence oblique laser beam has a fluence of about 50% of the high fluence normal laser beam and the high fluence normal laser beam may have, for example, a fluence of about 200 J/cm². In another more particular embodiment of the method, the first low fluence oblique laser beam is used to form only a single row of first low fluence laser shock peened spots in the border area.

Another embodiment of the method further includes laser shock peening a first portion of the border area bordering the first area with the first low fluence oblique laser beam and laser shock peening a second portion of the border area between the first area and the non-laser shock peened area with a second low fluence oblique laser beam wherein the second low fluence oblique laser beam has a lower fluence than the first low fluence oblique laser beam. In a more particular embodiment of the method, the first low fluence oblique laser beam has a fluence of about 50% of the high fluence normal laser beam. The second low fluence oblique laser beam may have a fluence of about 50% of the first low fluence oblique laser beam. The high fluence normal laser beam may have a fluence of about 200 J/cm² in another more particular embodiment.

Another embodiment of the method further includes laser shock peening the border area with progressively lower fluence oblique laser beams starting with the one first low fluence oblique laser beam wherein the progressively lower fluence oblique laser beams are in order of greatest fluence to least fluence in a direction outwardly from the first area through the border area to the non-laser shock peened area. A more particular embodiment of the method further includes, forming high fluence laser shock peened spots in the first area, forming first low fluence laser shock peened spots in the border area, and operating the high fluence normal and low fluence oblique laser beams at the same power or energy level wherein the first low fluence laser shock peened spots are larger in area than the high fluence laser shock peened spots.

### BRIEF DESCRIPTION OF THE DRAWINGS

FIG. 1 is a perspective view illustration of a fan blade exemplifying an article laser shock peened with a high fluence normal laser beam in a first area and a low fluence oblique laser beam in a border area between the first area and a non-laser shock peened area of the article.

FIG. 2 is a cross-sectional view illustration of the laser shock peened areas at a leading edge of an airfoil of the fan blade illustrated in FIG. 1.

FIG. 3 is an exemplary schematic illustration of a method to laser shock peen the article in FIG. 1, with the high fluence normal laser beam in the first area and the low fluence oblique laser beam in the border area between the first area and the non-laser shock peened area of the article.

FIG. 4 is a diagrammatic illustration of a laser shock peening method using two rows of progressively lower fluence laser shock peened spots in the border area illustrated in FIG. 3.

FIG. 5 is a diagrammatic illustration of a laser shock peening method using three rows of progressively lower fluence laser shock peened spots in the border area illustrated in FIG. 3.

FIG. 6 is a diagrammatic illustration of a feathered laser shock peening method using rows of progressively lower fluence laser shock peened spots for a feathered effect in the border area illustrated in FIG. 3.

### DETAILED DESCRIPTION OF THE INVENTION

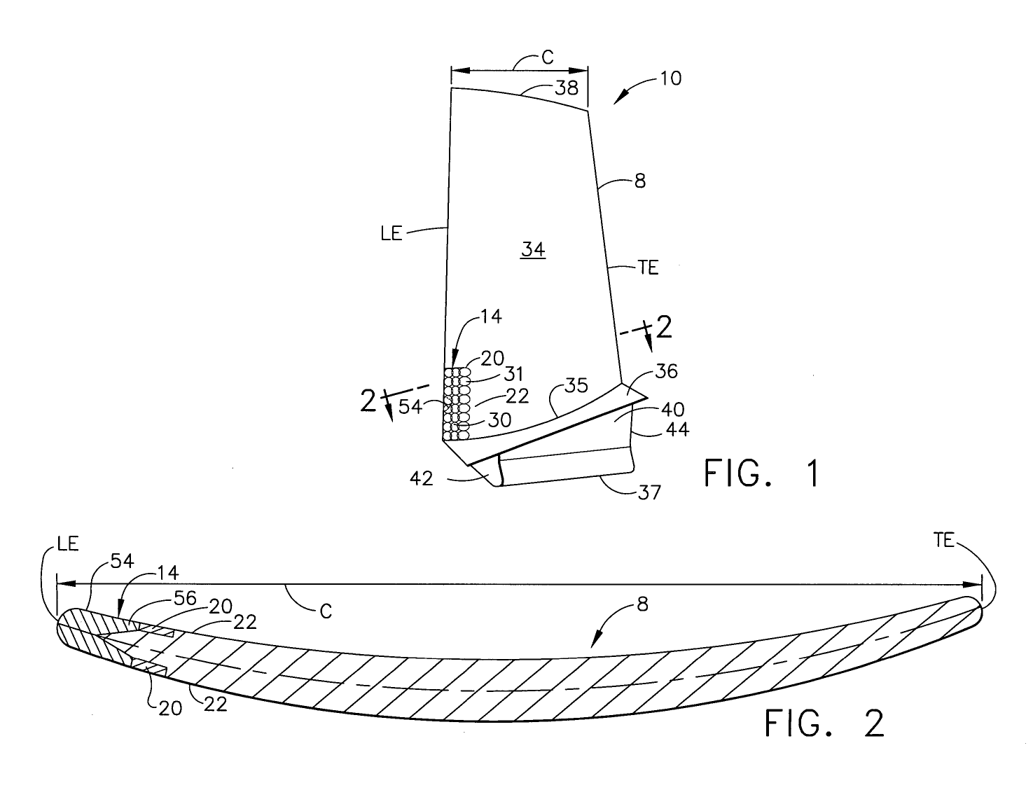

Illustrated in FIGS. 1 and 2 is a fan blade 8 having an airfoil 34 made of a Titanium alloy extending radially outward from a blade platform 36 and from a blade base 35 to a blade tip 38. The blade 8 is representative of a hard metallic article 10 for which lower fluence boundary laser shock peening was developed. The fan blade 8 includes a root section 40 extending radially inward from the platform 36 to a radially inward end 37 of the root section 40. At the radially inward end 37 of the root section 40 is a blade root 42 which is connected to the platform 36 by a blade shank 44. The airfoil 34 extends in the chordwise direction between a leading edge LE and a trailing edge TE of the airfoil. A chord C of the airfoil 34 is the line between the leading LE and trailing edge TE at each cross-section of the blade.

It is well known to use laser shock peening to counter possible fatigue failure of portions of an article. Typically, one or both sides of the article such as the blade 8 are laser shock peened producing laser shock peened patches or surfaces 54 and pre-stressed regions 56 having deep compressive residual stresses imparted by a laser shock peening (LSP) method extending into the article from the laser shock peened surfaces 54.

The exemplary laser shock peened surfaces 54 illustrated in FIGS. 1 and 2 are along a portion of the leading edge LE. The laser shock peening imparted compressive residual stresses in the pre-stressed regions 56 are balanced by residual tensile stresses that extend into the blade in an area bordering the laser shock peened patches or surfaces 54 which may locally lower laser shock peened enhanced fatigue capability of the blade or other article near the laser shock peened surfaces 54. Lower fluence boundary laser shock peening in a border area 20 between a first area 14 of high fluence laser shock peening and a non-laser shock peened area 22 outside of the laser shock peened patches or surfaces 54 was developed to reduce these residual tensile stresses and minimize or eliminate lowered fatigue capability.

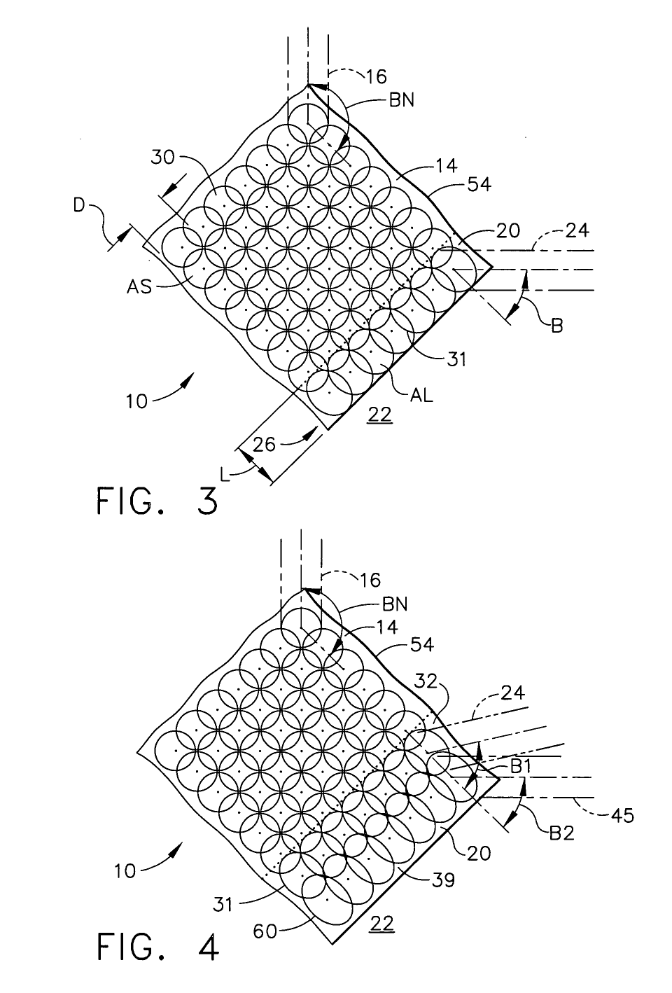

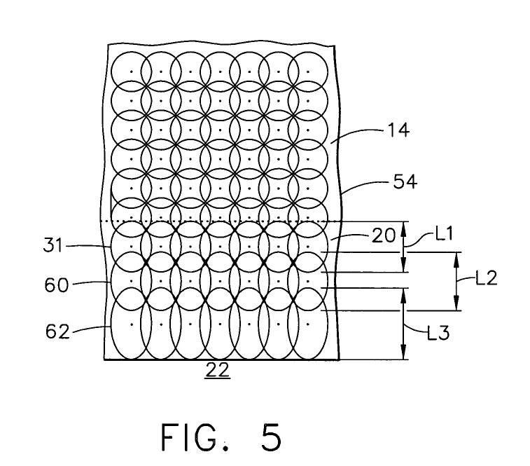

FIG. 3 illustrates a lower fluence boundary laser shock peening method for laser shock peening an article such as the fan blade 8. The method includes laser shock peening the first area 14 with at least one high fluence normal laser beam 16 and laser shock peening the border area 20 between the first area 14 and the non-laser shock peened area 22 of the article 10 with at least one first low fluence oblique laser beam 24. The high fluence normal laser beam 16 is normal to the laser shock peening surface 54 at a 90 degree or normal angle BN with respect to the surface 54. The low fluence oblique laser beam laser 24 is angled at an oblique angle B with respect to the surface 54.

In one exemplary embodiment of the method, the first low fluence oblique laser beam 24 has a fluence at the surface 54 of about 50% of the high fluence normal laser beam 16. One particularly useful fluence of the high fluence normal laser beam 16 is about 200 J/cm². The laser beams may be of the same power and have the same fluence on a surface normal to them but by adjusting either the laser beam or the surface 54 such that the laser beam is oblique to the surface 54 of the article 10. An oblique beam produces an oval laser beam spot while a normal beam produces a circular laser beam spot. If both beams are of equal power, then the fluence across the oval laser beam spot is less than the fluence across the circular laser beam spot. Thus, the same beam may be used to laser shock peen the first area 14 with high fluence laser shock peening and the border area 20 with lower fluence boundary laser shock peening.

High fluence laser shock peened spots 30 formed in the first area 14 are illustrated in FIG. 3 as being circular and having a diameter D and small spot area AS. First low fluence laser shock peened spots 31 formed in the border area 20 are illustrated as being oval and having a width equal to the diameter D, a length L, and a large spot area AL. This indicates that the high fluence normal laser beam 16 and the first low fluence oblique laser beam 24 may have the same diameter and power but different laser beam cross-sectional areas and fluences at the surface 54. Alternatively, the high fluence normal laser beam 16 and the first low fluence oblique laser beam 24 may be of different powers or energy levels. The method is designed to use either high energy laser beams, from about 20 to about 50 joules, or low energy laser beams, from about 3 to about 10 joules, as well as other levels. See, for example, U.S. Pat. No. 5,674,329, issued Oct. 7, 1997, (LSP process using high energy lasers) and U.S. Pat. No. 5,932,120, issued Aug. 3, 1999, (LSP process using low energy lasers).

The combination of the energy of the laser and the size of the laser beam provides an energy density or fluence that is usually up to about 200 J/cm² for the high fluence normal laser beam 16 though somewhat lower fluences may be used. The high fluence laser shock peened spots 30 are illustrated as having a circular shape but may have other shapes such as oval or elliptical (see U.S. Pat. No. 6,541,733, entitled “Laser Shock Peening Integrally Bladed Rotor Blade Edges” by Mannava, et al., issued Apr. 1, 2003). The low fluence laser shock peened spots 31 are illustrated as having an oval shape but may have other shapes such as elliptical. The laser shock peened spots are typically formed in overlapping rows of overlapping spots. Overlaps of about 30% of the diameters between both spots in a row and between spots in adjacent rows is one particular design.

In the embodiment of the method illustrated in FIG. 3, the first low fluence oblique laser beam 24 is used to produce only a single row 26 of first low fluence laser shock peened spots 31 in the border area 20. Another embodiment of the method illustrated in FIG. 4 includes laser shock peening a first portion 32 of the border area 20 bordering the first area 14 with the first low fluence oblique laser beam laser 24 at a first oblique angle B1 with respect to surface 54 and laser shock peening a second portion 39 of the border area 20 between the first portion 32 and the non-laser shock peened area 22 with a second low fluence oblique laser beam 45 at a smaller second oblique angle B2 with respect to surface 54. The second low fluence oblique laser beam 45 has a lower fluence than the first low fluence oblique laser beam 24 because, though, the same laser beam is used, the second oblique angle B2 is smaller than the first oblique angle B1. The same laser beam at three different angles, a normal angle BN and first and second oblique angles B1 and B2 may be used to laser shock peen the surface 54 to form the high fluence laser shock peened first area 14 and the lower fluence laser shock peened border area 20. In a more particular embodiment of the method, the first low fluence oblique laser beam 24 has a fluence of about 50% of the high fluence normal laser beam 16. The second low fluence oblique laser beam 45 may have a fluence of about 50% of the first low fluence oblique laser beam 24. A particularly useful fluence of the high fluence normal laser beam 16 is about 200 J/cm². Other numbers of low fluence oblique laser beams may be used such as three indicated by first, second, and third rows of first, second, and third low fluence laser shock peened spots 31, 60, and 62, respectively, in the border area 20 illustrated in FIG. 5.

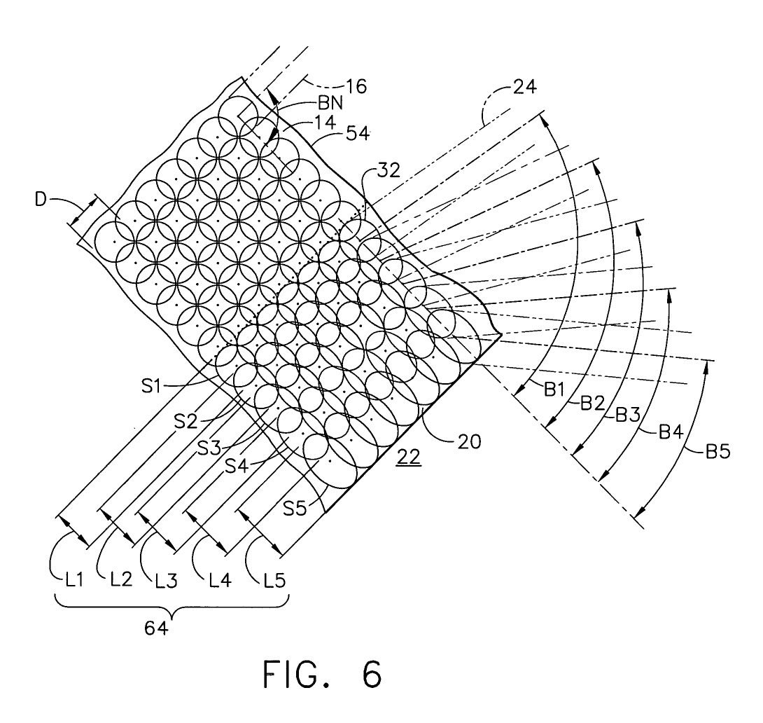

FIG. 6 illustrates feathering the border area 20 by laser shock peening the border area 20 with progressively lower fluence oblique laser beams indicated by progressively lower fluence laser shock peened spots 64 starting with the one first low fluence oblique laser beam 24 wherein the progressively lower fluence oblique laser beams are in order of greatest fluence to least fluence in a direction outwardly from the first area through the border area 20 to the non-laser shock peened area 22. The progressively lower fluence oblique laser beams are produced by angling the same power lower fluence oblique laser beams at progressively lower or smaller oblique angles illustrated as first through fifth oblique angles B1-B5 with respect to surface 54. Corresponding low fluence first through fifth oval laser shock peened spots S1-S5 have the same width as the circular diameter D of the circular laser shock peened spots and progressively longer first through fifth lengths L1-L5. Feathering can be done with three or four or more rows of low fluence oblique laser beams. One exemplary feathering method includes feathering from 200 J/cm² for the high fluence normal laser beam down to 50 J/cm² in −50 J/cm² increments, thus, having three rows of low fluence laser shock peened spots produced with 150 J/cm², 100 J/cm², and 50 J/cm² fluence oblique laser beams, respectively. Another exemplary feathering method includes feathering from 200 J/cm² for the high fluence normal laser beam down to 25J/cm² in −20 J/cm² increments, thus, having seven rows of low fluence laser shock peened spots produced with 175 J/cm², 150 J/cm², 125 J/cm², 100 J/cm², 75 J/cm², 50 J/cm², and 25 J/cm² fluence oblique laser beams, respectively, and operating the high fluence normal laser beam 16 and low fluence oblique laser beams 24 at the same power or energy level.

The exemplary embodiments of the lower fluence boundary oblique laser shock peening method disclosed above have been described in terms of the high fluence normal laser beam 16 being used in the first area 14 of high fluence laser shock peening. Alternatively, a high oblique angle laser beam may be used which, though not normal to the surface 54, has a high fluence when compared to the low fluence oblique laser beam or beams 24. The same laser used to produce the high oblique angle laser beam can be used to produce the low fluence oblique laser beam or beams 24. The lower fluence oblique laser beams are angled at significantly smaller oblique angles as compared to a high oblique angle of the high oblique angle laser beam with respect to surface 54.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

Accordingly, what is desired to be secured by Letters Patent of the United States is the invention as defined and differentiated in the following claims:

1. A method for laser shock peening an article, said method comprising:
laser shock peening a first area of a laser shock peening surface with at least one high fluence normal laser beam that is normal with respect to the surface, and
laser shock peening a border area of the surface between the first area and a non-laser shock peened area of the article with at least one first low fluence oblique laser beam that is oblique with respect to the surface.

2. A method as claimed in claim 1, wherein the first low fluence oblique laser beam has a fluence of about 50% of the high fluence normal laser beam.

3. A method as claimed in claim 2, wherein the high fluence normal laser beam has a fluence of about 200 J/cm².

4. A method as claimed in claim 2, wherein the first low fluence oblique laser beam is used to produce only a single row of first low fluence laser shock peened spots in the border area.

5. A method as claimed in claim 4, wherein the high fluence normal laser beam has a fluence of about 200 J/cm².

6. A method as claimed in claim 1, further comprising laser shock peening a first portion of the border area bordering the first area with the first low fluence oblique laser beam laser, laser shock peening a second portion of the border area between the first area and the non-laser shock peened area with a second low fluence oblique laser beam wherein the second low fluence oblique laser beam has a lower fluence than the first low fluence oblique laser beam.

7. A method as claimed in claim 6, wherein the first low fluence oblique laser beam has a fluence of about 50% of the high fluence normal laser beam.

8. A method as claimed in claim 7, wherein the second low fluence oblique laser beam has a fluence of about 50% of the first low fluence oblique laser beam.

9. A method as claimed in claim 6, wherein the high fluence normal laser beam has a fluence of about 200 J/cm².

10. A method as claimed in claim 9, wherein the first low fluence oblique laser beam has a fluence of about 50% of the high fluence normal laser beam.

11. A method as claimed in claim 10, wherein the second low fluence oblique laser beam has a fluence of about 50% of the first low fluence oblique laser beam.

12. A method as claimed in claim 1, further comprising laser shock peening the border area with progressively lower fluence laser beams starting with the one first low fluence oblique laser beam wherein the progressively lower fluence oblique laser beams are in order of greatest fluence to least fluence in a direction outwardly from the first area through the border area to the non-laser shock peened area and at progressively smaller oblique angles with respect to the surface.

13. A method as claimed in claim 1, further comprising:
forming high fluence laser shock peened spots in the first area with the high fluence normal laser beam,
forming first low fluence laser shock peened spots in the border area with the low fluence oblique laser beams, and
operating the high and low fluence oblique laser beams at the same power.

14. A method as claimed in claim 13, wherein the first low fluence oblique laser beam has a fluence of about 50% of the high fluence normal laser beam.

15. A method as claimed in claim 14, wherein the high fluence normal laser beam has a fluence of about 200 J/cm².

16. A method as claimed in claim 13, wherein the first low fluence oblique laser beam is used to produce only a single row of first low fluence laser shock peened spots in the border area.

17. A method as claimed in claim 16, wherein the high fluence normal laser beam has a fluence of about 200 J/cm².

18. A method as claimed in claim 13, further comprising laser shock peening a first portion of the border area bordering the first area with the first low fluence oblique laser beam laser, laser shock peening a second portion of the border area between the first area and the non-laser shock peened area with a second low fluence oblique laser beam wherein the second low fluence oblique laser beam has a lower fluence than the first low fluence oblique laser beam.

19. A method as claimed in claim 18, wherein the first low fluence oblique laser beam has a fluence of about 50% of the high fluence normal laser beam.

20. A method as claimed in claim 19, wherein the second low fluence oblique laser beam has a fluence of about 50% of the first low fluence oblique laser beam.

21. A method as claimed in claim 18, wherein the high fluence normal laser beam has a fluence of about 200 J/cm².

22. A method as claimed in claim 21, wherein the first low fluence oblique laser beam has a fluence of about 50% of the high fluence normal laser beam.

23. A method as claimed in claim 22, wherein the second low fluence oblique laser beam has a fluence of about 50% of the first low fluence oblique laser beam.

24. A method as claimed in claim 13, further comprising laser shock peening the border area with progressively lower fluence laser beams starting with the one first fluence laser beam wherein the progressively lower fluence laser beams are in order of greatest fluence to least fluence in a direction outwardly from the first area through the border area to the non-laser shock peened area.

25. A laser shock peened article comprising:
a laser shock peened surface having a laser shock peened first area and a laser shock peened border area between the first area and a non-laser shock peened area of the article,
wherein the laser shock peened first area was laser shock peened with at least one high fluence normal laser beam, and
wherein the laser shock peened border area was laser shock peened with at least one first low fluence oblique laser beam.

26. An article as claimed in claim 25, wherein the laser shock peened border area was laser shock peened with the first low fluence oblique laser beam having a fluence of about 50% of the high fluence normal laser beam.

27. An article as claimed in claim 26, wherein the laser shock peened first area was laser shock peened with the high fluence normal laser beam having a fluence of about 200 J/cm².

28. An article as claimed in claim 26 further comprising only a single row of first low fluence laser shock peened spots in the border area.

29. An article as claimed in claim 28, wherein the laser shock peened first area was laser shock peened with the high fluence normal laser beam having a fluence of about 200 J/cm².

30. An article as claimed in claim 25, further comprising:
a first portion of the border area bordering the first area,
a second portion of the border area between the first area and the non-laser shock peened area,
wherein the first portion was laser shock peened with the first low fluence oblique laser beam laser and the second portion was laser shock peened with a second low fluence oblique laser beam, and
wherein the second low fluence oblique laser beam had a lower fluence than the first low fluence oblique laser beam.

31. An article as claimed in claim 30, wherein the first low fluence oblique laser beam had a fluence of about 50% of the high fluence normal laser beam.

32. An article as claimed in claim 31, wherein the second low fluence oblique laser beam had a fluence of about 50% of the first low fluence oblique laser beam.

33. An article as claimed in claim 30, wherein the high fluence normal laser beam had a fluence of about 200 J/cm².

34. An article as claimed in claim 33, wherein the first low fluence oblique laser beam had a fluence of about 50% of the high fluence normal laser beam.

35. An article as claimed in claim 34, wherein the second low fluence oblique laser beam had a fluence of about 50% of the first low fluence oblique laser beam.

36. An article as claimed in claim 25, wherein the border area was laser shock peened with progressively lower fluence laser beams starting with the one first fluence laser beam wherein the progressively lower fluence laser beams were in order of greatest fluence to least fluence in a direction outwardly from the first area through the border area to the non-laser shock peened area.

37. An article as claimed in claim 25, further comprising:
overlapping rows of overlapping high fluence laser shock peened spots in the first area formed with the high fluence normal laser beam, and
overlapping first low fluence laser shock peened spots in the border area formed with the low fluence oblique laser beams, and
wherein the high and low fluence oblique laser beams had the same power.

38. An article as claimed in claim 37, wherein the first low fluence oblique laser beam had a fluence of about 50% of the high fluence normal laser beam.

39. An article as claimed in claim 38, wherein the high fluence normal laser beam had a fluence of about 200 J/cm².

40. An article as claimed in claim 37, further comprising only a single row of first low fluence laser shock peened spots in the border area.

41. An article as claimed in claim 40, wherein the high fluence normal laser beam had a fluence of about 200 J/cm².

42. An article as claimed in claim 37, further comprising:
a first portion of the border area bordering the first area,
a second portion of the border area between the first area and the non-laser shock peened area,
wherein the first portion was laser shock peened with the first low fluence oblique laser beam laser and the second portion was laser shock peened with a second low fluence oblique laser beam, and
wherein the second low fluence oblique laser beam had a lower fluence than the first low fluence oblique laser beam.

43. An article as claimed in claim 42, wherein the first low fluence oblique laser beam had a fluence of about 50% of the high fluence normal laser beam.

44. An article as claimed in claim 43, wherein the second low fluence oblique laser beam has a fluence of about 50% of the first low fluence oblique laser beam.

45. An article as claimed in claim 42, wherein the high fluence normal laser beam had a fluence of about 200 J/cm².

46. An article as claimed in claim 45, wherein the first low fluence oblique laser beam had a fluence of about 50% of the high fluence normal laser beam.

47. An article as claimed in claim 46, wherein the second low fluence oblique laser beam had a fluence of about 50% of the first low fluence oblique laser beam.

48. A method for laser shock peening an article, said method comprising:
laser shock peening a first area of a laser shock peening surface with at least one high fluence laser beam angled at a large oblique angle with respect to the surface, and
laser shock peening a border area of the surface between the first area and a non-laser shock peened area of the article with at least one first low fluence oblique laser beam angled at a low oblique angle with respect to the surface wherein the low oblique angle is smaller than the large oblique angle.

49. A method as claimed in claim 48, wherein the first low fluence oblique laser beam is used to produce only a single row of first low fluence laser shock peened spots in the border area.

50. A method as claimed in claim 48, further comprising laser shock peening a first portion of the border area bordering the first area with the first low fluence oblique laser beam laser, laser shock peening a second portion of the border area between the first area and the non-laser shock peened area with a second low fluence oblique laser beam wherein the second low fluence oblique laser beam has a lower fluence and a smaller oblique angle to the surface than the first low fluence oblique laser beam.

51. A method as claimed in claim 48, further comprising laser shock peening the border area with progressively lower fluence laser beams starting with the one first low fluence oblique laser beam wherein the progressively lower fluence oblique laser beams are in order of greatest fluence to least fluence in a direction outwardly from the first area through the border area to the non-laser shock peened area and at progressively smaller oblique angles with respect to the surface.

52. A method as claimed in claim 48, further comprising operating the high and low fluence oblique laser beams at the same power.
